(19) United States
(12) Patent Application Publication
(10) Pub. No.: US 2020/0265440 A1
(43) Pub. Date: Aug. 20, 2020

(54) TRANSACTION VALIDATION FOR PLURAL ACCOUNT OWNERS

(71) Applicant: INTERNATIONAL BUSINESS MACHINES CORPORATION, Armonk, NY (US)

(72) Inventors: Shadi ALBOUYEH, Raleigh, NC (US); Trudy L. HEWITT, Cary, NC (US); Jonathan DUNNE, Dungarvan (IE); Jeremy Adam GREENBERGER, San Jose, CA (US)

(21) Appl. No.: 16/279,333

(22) Filed: Feb. 19, 2019

(51) Int. Cl. G06Q 20/42; G06F 16/23; G06Q 20/20; G06F 21/31

(52) U.S. Cl. CPC G06Q 20/425; G06F 21/31; G06Q 20/20; G06F 16/23

(57) ABSTRACT

A computer-implemented method includes receiving, by a computer device, an electronic notice of a current transaction being attempted by a first user at an electronic transaction device, the current transaction requiring access to a joint account, the first user and a second user having authority to access an asset in the joint account; comparing in real time, by the computer device, the current transaction to historical classification data; classifying in real time, by the computer device, the current transaction based on the comparing; and transmitting in real time, by the computer device, to the electronic transaction device an electronic communication indicating the current transaction is approved based on determining one of: the current transaction is classified as pre-approved; and the current transaction is classified as non-pre-approved and the current transaction does not exceed a predetermined threshold.

### BACKGROUND

The present invention relates generally to transactions requiring multi-party approval and, more particularly, to real-time validation of transactions involving multi-party approval.

Many relationships, both personal and business, involve two or more people that have joint access to financial accounts, hard assets, locations, or other jointly held assets. In some instances it is preferable to require joint authorization by two or more of the people in the relationship before transactions involving the financial accounts, hard assets, locations, or other jointly held assets take place.

### SUMMARY

In a first aspect of the invention, there is a computer-implemented method including: receiving, by a computer device, an electronic notice of a current transaction being attempted by a first user at an electronic transaction device, the current transaction requiring access to a joint account, the first user and a second user having authority to access an asset in the joint account; comparing in real time, by the computer device, the current transaction to historical classification data; classifying in real time, by the computer device, the current transaction based on the comparing; and transmitting in real time, by the computer device, to the electronic transaction device an electronic communication indicating the current transaction is approved based on determining one of: the current transaction is classified as pre-approved; and the current transaction is classified as non-pre-approved and the current transaction does not exceed a predetermined threshold.

In another aspect of the invention, there is a computer program product including a computer readable storage medium having program instructions embodied therewith. The program instructions are executable by a computing device to cause the computing device to: receive an electronic notice of a current transaction being attempted by a first user at an electronic transaction device, the current transaction requiring access to a joint account, the first user and a second user having authority to access an asset in the joint account; compare in real time the current transaction to historical classification data; classify in real time the current transaction based on the comparing; and transmit in real time to the electronic transaction device an electronic communication indicating the current transaction is denied, wherein the denial is based on determining the current transaction is classified as non-pre-approved, the current transaction exceeds a predetermined threshold, and non-receipt of approval from the second user of the current transaction.

In another aspect of the invention, there is system including a processor, a computer readable memory, and a computer readable storage medium. The system includes: program instructions to receive an electronic notice of a current transaction being attempted by a first user at an electronic transaction device, the current transaction requiring access to a joint account, the first user and a second user having authority to access an asset in the joint account; program instructions to compare in real time the current transaction to historical classification data; program instructions to classify in real time the current transaction based on the comparing; and program instructions to transmit in real time to the electronic transaction device an electronic communication indicating the current transaction is denied. The denial is based on determining the current transaction is classified as non-pre-approved, the current transaction exceeds a predetermined threshold, and non-receipt of approval from the second user of the current transaction. The program instructions are stored on the computer readable storage medium for execution by the processor via the computer readable memory.

### BRIEF DESCRIPTION OF THE DRAWINGS

The present invention is described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows a block diagram of an exemplary environment in accordance with aspects of the invention.

FIG. 5 shows a flowchart of an exemplary method in accordance with aspects of the invention.

### DETAILED DESCRIPTION

The present invention relates generally to transactions requiring multi-party approval and, more particularly, to real-time validation of transactions involving multi-party approval. According to aspects of the invention an attempted transaction is compared to historical classification data to classify the attempted transaction as either pre-approved or non-pre-approved. If the attempted transaction is classified as non-pre-approved, the system requests, in real time, approval of the transaction from a joint owner of the account involved in the transaction. In embodiments, a threshold is also established for transactions to determine if approval of the transaction by a joint owner of the account is required. In this manner, implementations of the invention provide joint account owners with the added security of particular classes of transactions requiring two-party approval.

Advantageously, embodiments of the invention provide improvements to the technical field of point of sale, and other, transactions. By requiring the approval in real time of a non-pre-approved transaction by a second joint account owner based on historical data, embodiments of the invention improve the security of jointly held accounts and improve the speed and efficiency in which joint accounts are securely used. Embodiments of the invention also employ an unconventional arrangement of steps including: comparing in real time a current transaction to historical classification data to determine if the transaction is pre-approved or non-pre-approved; and requesting approval in real time of a second joint account owner of the transaction. The steps themselves are unconventional, and the combination of the steps is also unconventional. For example, the step of requesting in real time the approval of a second joint account owner creates new information that does not exist in the system (historical classification data), and this new information is then used in subsequent steps in an unconventional manner.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

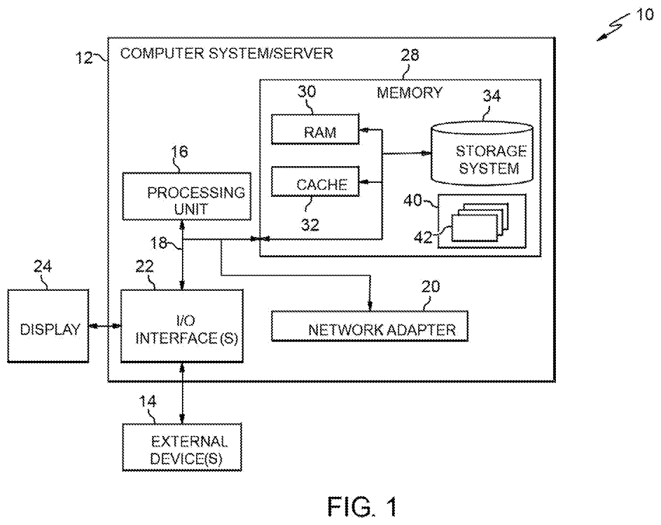

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

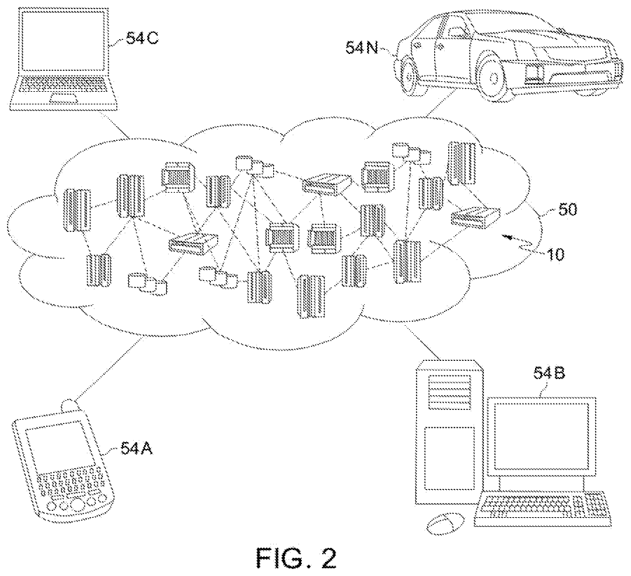

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

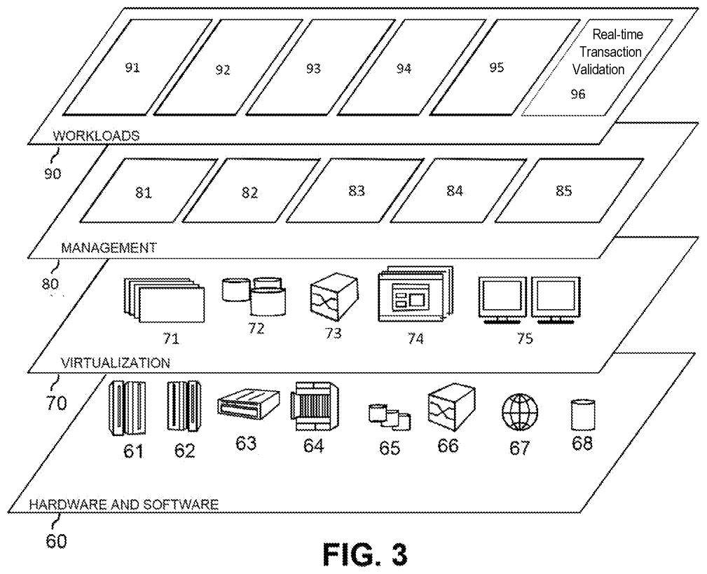

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and real-time transaction validation 96.

Implementations of the invention may include a computer system/server 12 of FIG. 1 in which one or more of the program modules 42 are configured to perform (or cause the computer system/server 12 to perform) one of more functions of the real-time transaction validation 96 of FIG. 3. For example, the one or more of the program modules 42 may be configured to: receive an electronic notice of a current transaction being attempted by a first user at an electronic transaction device; compare in real time the current transaction to historical classification data; classify in real time the current transaction based on the comparing; if the current transaction is classified as pre-approved, decide in real time that the current transaction is approved; if the current transaction is classified as non-pre-approved, determine in real time whether the current transaction exceeds a predetermined threshold; if the current transaction exceeds the predetermined threshold, request in real time approval from a second user of the current transaction; if the approval is requested from the second user, receive in real time a communication from the second user indicating whether the current transaction is approved; and transmit in real time to the electronic transaction device an electronic communication indicating whether the current transaction is approved.

Joint bank accounts (and other types of accounts) with multiple people having withdrawal authority often offer limited protection or control over withdrawals by any one of the authorized people. For example, business partners may have different understandings as to the current financial condition of the business and, as a result, have different current understandings as to the importance of a particular purchase. In another example, spouses or other domestic partners may have different understandings as to the current financial condition of the household and, as a result, have different current understandings as to the importance of a particular purchase. In either of these, or other, situations there may not have been the time or conditions for notification between the partners. Embodiments of the invention provide real time plural validation to ensure agreement before purchases or other transactions are made from joint accounts. While examples in this disclosure involve monetary withdrawal transactions regarding bank accounts or other accounts, other examples of the invention involve deposits to financial or other accounts, access to secure buildings or particular rooms or areas of a building, checking-out equipment (computers, vehicles, projectors, etc.), using services within an organization, or any other instance where a transaction by one person requires the authorization or validation of another person.

Embodiments of the invention provide real time approval at the time point-of-sale (POS) is occurring while considering various classes of purchase items, locations, and cost thresholds. Embodiments provide the ability to monitor transactions and trigger real time approval prior to approving the transaction. Embodiments are not limited to monetary transactions, but also include non-monetary triggers.

Embodiments of the invention include a system and method that passively monitors transactions for a joint (personal or business) account and triggers real time approval from plural account owners prior to approving the transaction if the transaction matches a pattern of historic transactions which haves been identified as not having the joint approval of both of the account holders. Although some of the examples given in this disclosure have two account holders, other examples involve three or more account holders. In some examples, all account holders must agree to a transaction before the transaction is approved. In some example, a majority (or some other percentage) of the account holders must agree to a transaction before the transaction is approved.

In embodiments, prior data such as, for example, historic transactions are analyzed and classified as non-pre-approved or pre-approved. In embodiments, the prior transactions (or other data) are used as training data to develop a historical database that is referred to during later transactions. A new transaction is compared against the historical database to determine if the new transaction is classified as a non-pre-approved or pre-approved transaction. If the new transaction is classified as a non-pre-approved transaction, then a request for real time approval is triggered.

In embodiments, real time requests for approval are sent out by a computer device when point of sale (POS) transactions occur that exceed a predetermined threshold. The requests for approval are sent to one or more of the joint account holders at the same time, and prior to the POS transaction being completed. An advantage of embodiments of the invention is the ability to enable account owners to collaborate and approve joint purchases.

Embodiments enable users to transfer funds/money from a family member's account if they are authorized to do so, based on an approved need. The approval of the need is provided dynamically using embodiments of the invention described herein. In embodiments, transactions are not necessarily monetary type transactions. Embodiments of the invention provide the dynamic, real time approval (or non-approval) of attempts to access secure locations or buildings.

Exemplary embodiments perform analysis of transaction history from joint accounts (price, purchaser, product, location, etc) and if a historic pattern is recognized and past approval was given, the system uses that information to decide that the current transaction is approved. Embodiments use prior history of the type of transactions which have been classified as non-pre-approved, and use this historical classification data is used as training data to build a classifier model in a historical database. In embodiments, a transaction discriminant model (for example using linear discriminant analysis) is used to build the classification model by separating all of the data into two classifications: pre-approved and non-pre-approved. Application of this model is then used to infer which transaction types are likely to be non-pre-approved. Embodiments implement a two phased approach for prior non-pre-approved transactions. For example, if a person has a history of attempting non-pre-approved transactions, a two phased transaction approach is applied for all transactions by that person. For example, when a purchase is attempted at point of sale, the system compares the attempted purchase to the historical classification data in the historical database to classify the attempted purchase as pre-approved or non-pre-approved. If the attempted purchase is classified as non-pre-approved, the system determines whether or not the attempted purchase exceeds a predetermined threshold (for example, a set dollar amount). If the system determines that the attempted purchase exceeds the predetermined threshold, the system requests, in real time, approval from a joint account holder other than the person. If the joint account holder withholds approval of the attempted transaction, then the transaction is blocked at POS.

In embodiments, social/location factors are added into the historical classification data and used by the system in deciding if a non-pre-approved transaction is being attempted. For example, in embodiments, for a particular person purchases of a particular type at a particular location are classified as non-pre-approved while other types of purchases at the same location are classified as pre-approved.

Some embodiments classify all transactions at a certain location as non-pre-approved. In this example, the system would initiate and trigger an approval request from a joint account owner to approval of the transaction prior to it being processed. In some embodiments, approval is requested via a telecommunication network such as, for example, a mobile phone network. In embodiments, approval is given by a password, a fingerprint, voice recognition, or some other form of identification.

Examples of systems in accordance with embodiments of the invention are built using a number of different classier systems using a discriminant function in the programming language ROR. Embodiments use the scikit-learn toolkit in Python using either Naive Bayes or SVM classifiers. Embodiments use a natural language interface to build entities to detect transaction logic as non-pre-approved or pre-approved. In embodiments, the system has a human feedback loop to provide additional learning and classification fidelity (e.g. false positive, false negative reporting).

To the extent implementations of the invention collect, store, or employ personal information provided by, or obtained from, individuals (for example, historical classification data, current transaction, etc.), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information. In embodiments of the invention, users are required to opt-in to the system before personal data of the user is collected and/or used by the system.

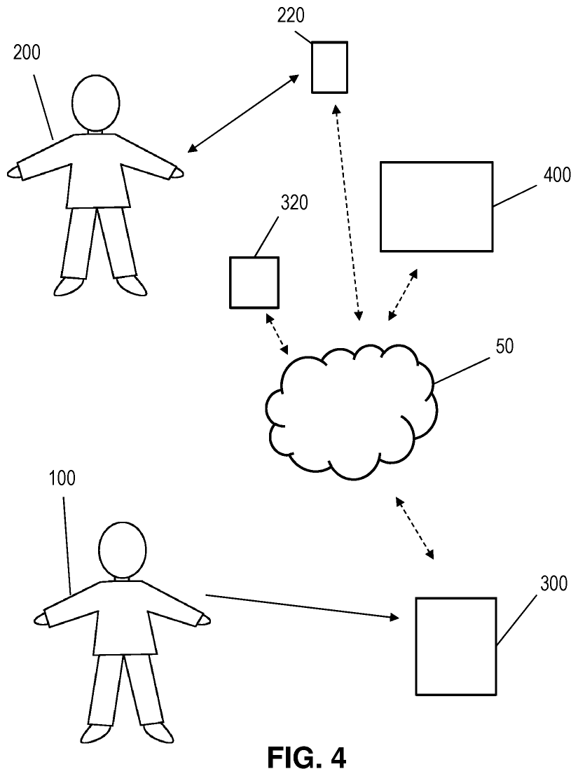

FIG. 4 shows a block diagram of an exemplary environment in accordance with aspects of the invention. In embodiments, the environment includes an electronic transaction device 300 such as, for example, a point of sale (POS) electronic transaction device. In embodiments, the electronic transaction device 300 is a cash register or other electronic device that conducts purchase transactions. In other embodiments, the electronic transaction device 300 is a security access device such as, for example, a card reader, finger print scanner, or iris scanner that controls access to a secured area or building.

In embodiments, a first user 100 attempts a current transaction through the electronic transaction device 300. In embodiments, the attempted transaction is the purchase of goods or services. In other embodiments, the attempted transaction is access to a secured area or building. The attempted current transaction is processed by a service provider 320 that is, in this example, connected to the electronic transaction device 300 through the cloud computing environment 50. In other examples, the service provider 320 is connected to the electronic transaction device 300 by a hardwired or wireless connection. In embodiments, the service provider 320 is a financial institution, such as a bank, that provides funds that the first user 100 is using to complete the purchase. In other embodiments, the service provider 320 is a security company that controls who has access to a secured area or building. In still other embodiments, the service provider is any entity that provides authorization desired for completion of the transaction.

A computer device 400 is connected to the service provider 320 and/or the electronic transaction device 300 by, in this example, the cloud computing environment 50. In other examples, the computer device 400 is connected to the service provider 320 and/or the electronic transaction device 300 by a wired or wireless connection. In embodiments, the computer device 400 is, for example, computer system/server 12 shown in FIG. 1.

In embodiments of the invention, as discussed above, the current transaction involves a joint account that has two or more owners or other people with authority to access funds or other assets in the account. For example, the joint account can be a bank account owned by a partnership with two partners. In this case, both partners have access to the funds in the account. In other examples, the joint account is a security account or system in which two or more people have authority to access or grant access to a secured computer system, area or building.

When the current transaction is sent to the service provider 320, it is also sent to the computer device 400 to perform steps in accordance with embodiments of the invention. In embodiments, the electronic transaction device 300, the service provider 320, and/or the first user are not aware that the computer device 400 is performing functions of the invention.

Computer device 400, upon receiving an electronic notice of the current transaction, compares in real time the current transaction to historical classification data and classifies the current transaction as either per-approved or non-pre-approved based on the comparison. In some instances, the current transaction will precisely match a historical transaction and will, accordingly, be classified the same as that historical transaction. In other instances, the current transaction will not precisely match a historical transaction and will, in that case, be classified based on similar transactions that exists in the historical database. In embodiments, the historical database includes ranges of parameters used to classify the current transaction. For example, in embodiments, a purchase over a certain monetary amount or a purchase at a particular vendor will be classified as non-pre-approved. In embodiments, the computer device 400 classifies the current transaction without regard to a threshold and then only determines whether the current transaction exceeds a predetermined threshold if the current transaction is classified as non-pre-approved.

In embodiments, when the computer device 400 indicates that the current transaction is classified as non-pre-approved (and that the current transaction exceeds a predetermined threshold if required), the computer device 400 requests in real time approval of the transaction from a second person 200. In embodiments, for example, the second person 200 is a joint owner on the financial account from which funds are requested to complete the transaction. In another example, the second person is a person that has authority (along with the first person 100) to access a secured computer system or area.

In embodiments, a purpose of requesting approval of the second person 200 is to confirm that both the first person 100 and the second person 200, at the time of the transaction, believe that the transaction should take place. For example, the first person 100 is purchasing office furniture for an office that is used by a partnership owned by the first person 100 and the second person 200. At some point in time the second person 200 became aware of new information that indicates that the office furniture should not be purchased at this time, but the first person is not aware of this new information. Embodiments of the invention prevent this unwanted purchase by requiring the approval of the second person 200 before the transaction can be completed.

In embodiments, the computer device 400 communicates with the second person 200 through a mobile telecommunication device 220 such as, for example, a mobile telephone. In embodiments, when the second person 200 receives the request for approval, the second user responds to the request by either approving the request or denying the request. In embodiments, the response by the second person 200 is a verbal response, a text response or by touch screen selection. In embodiments, the response has a security feature such as, for example, a finger print scanner, an iris scanner, or a security question that identifies the responder as the second person 200. Upon receipt of the response of the second person 200, the computer device 400 transmits to the electronic transaction device 300 instructions to either approve or deny the transaction.

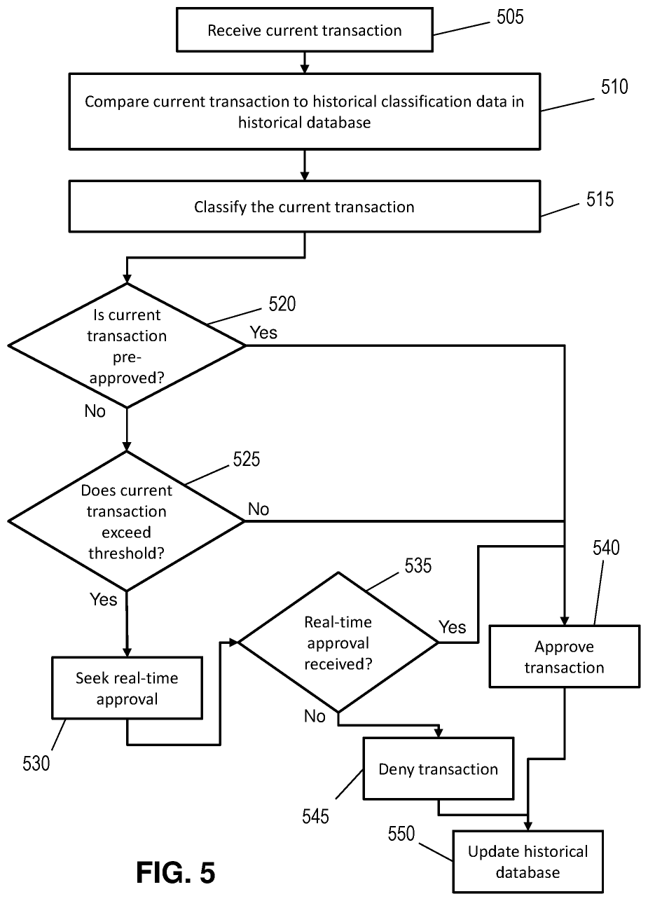

FIG. 5 shows a flowchart of an exemplary method in accordance with aspects of the present invention. Steps of the method may be carried out in the environment of FIG. 4 and are described with reference to elements depicted in FIG. 4.

At step 505, the computer device 400 receives from the electronic transaction device 300 information regarding the current transaction. In embodiments, the current transaction is a purchase and the information includes the amount of the purchase, the product or service being purchased, the vendor being purchased from, and the location of the purchase. At step 510, the computer device 400 compares the current transaction to historical classification data in a historical database. In embodiments, the historical transaction data includes information similar to that listed above.

At step 515, the computer device 400 classifies the current transaction as either pre-approved or non-pre-approved based on the comparison of the current transaction and the historical classification data. At step 520, if the current transaction is classified as pre-approved, then processing continues to step 540 and the computer device 400 send a communication to the electronic transaction device 300 indicating that the current transaction is approved. The electronic transaction device 300 then completes the current transaction. Processing then continues to step 550 where the historical database is updated with the information and approval decision related to the current transaction. This updating improves the accuracy of future classification by continually refining the data that is used for classification of future transactions.

If, at step 520, the current transaction is classified as non-pre-approved, processing continues to step 525 where the computer device 400 determines if the current transaction exceeds a predetermined threshold. In embodiments, the predetermined threshold is a monetary amount above which a transaction requires approval of the second person 200. In embodiments, the predetermined threshold is a monetary amount that differs depending on the vendor, the product or service purchased, and/or the location of the purchase.

At step 525, if the current transaction does not exceed the predetermined threshold, processing continues to step 540 and continues as described above. If the computer device 400 determines at step 525 that the current transaction exceeds the predetermined threshold, processing continues to step 530 and the computer device 400 requests, in real time, approval of the current transaction from the second user 200.

If, at step 535, the computer device 400 receives approval from the second user 200, then processing continues to step 540 and continues as described above. If, at step 535, the computer device 400 does not receive approval from the second user 200, then processing continues to step 545 and the computer device 400 transmits to the electronic transaction device 300 a denial of approval and the electronic transaction device 300 prevents completion of the current transaction. Then, at step 550, the historical database is updated with the information and denial decision related to the current transaction. This updating improves the accuracy of future classification by continually refining the data that is used for classification of future transactions.

Embodiments of the invention include a method for automatically classifying potential transactions to determine whether joint account owner approval is required. The method includes receiving information identifying historic transactions made from an account with multiple co-owners; classifying, using a natural language classifier, the historic transactions as being either non-pre-approved or pre-approved, based on the received information; building a classification model using the classified historic transactions as training data; in response to receiving a request to authorize a new transaction made by a first co-owner of the multiple co-owners, using the classification model to automatically classify the new transaction as being either non-pre-approved or pre-approved; and in response to the new transaction being classified as non-pre-approved, notifying a second co-owner of the multiple co-owners of the new transaction, and requiring the approval of the second co-owner to authorize the new transaction.

Embodiments also include updating the classification model based on whether the second co-owner authorizes the new transaction. In embodiments, the historic transactions and the new transaction are purchases; the information identifying the historic transactions includes price information, purchaser information, product information, and location information; and the request to authorize the new transaction is received from a point-of-sale device. In embodiments, the historic transactions and the new transaction are authentications into a secure computing system.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system/server 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
receiving, by a computer device, an electronic notice of a current transaction being attempted by a first user at an electronic transaction device, the current transaction requiring access to a joint account, the first user and a second user having authority to access an asset in the joint account;
comparing in real time, by the computer device, the current transaction to historical classification data;
classifying in real time, by the computer device, the current transaction based on the comparing; and
transmitting in real time, by the computer device, to the electronic transaction device an electronic communication indicating the current transaction is approved based on determining one of: the current transaction is classified as pre-approved; and the current transaction is classified as non-pre-approved and the current transaction does not exceed a predetermined threshold.

2. The computer-implemented method of claim 1, further comprising updating, by the computer device, a historical database that contains the historical classification data,
wherein the updating includes the current transaction, results of the classifying, results of the determining, and the communication from the second user.

3. The computer-implemented method of claim 1, further comprising:
receiving, by the computer device, historical transactions of the first user; and
classifying, by the computer device, each of the historical transactions as being one selected from the group consisting of: non-pre-approved, and pre-approved.

4. The computer-implemented method of claim 3, wherein the classifying of the historical transactions is performed using a natural language classifier.

5. The computer-implemented method of claim 1, wherein the current transaction is a purchase transaction.

6. The computer-implemented method of claim 5, wherein the classifying is based at least in part on the seller in the purchase transaction.

7. The computer-implemented method of claim 3, wherein the electronic transaction device is a point-of-sale electronic transaction device.

8. The computer-implemented method of claim 1, wherein the predetermined threshold is a cost of a purchase.

9. The computer-implemented method of claim 1, wherein the communication from the second user is received over a telecommunication network.

10. The computer-implemented method of claim 1, wherein the electronic communication indicating the current transaction is approved is transmitted to only the electronic transaction device.

11. The computer-implemented method of claim 1, wherein the first user and the second user have authority to access funds in a joint account, and
the current transaction is a transaction that withdraws funds from the joint account.

12. The computer-implemented method of claim 1, wherein the computer device includes software provided as a service in a cloud environment.

13. A computer program product, the computer program product comprising a computer readable storage medium having program instructions embodied therewith, the program instructions executable by a computing device to cause the computing device to:
receive an electronic notice of a current transaction being attempted by a first user at an electronic transaction device, the current transaction requiring access to a joint account, the first user and a second user having authority to access an asset in the joint account;
compare in real time the current transaction to historical classification data;
classify in real time the current transaction based on the comparing; and
transmit in real time to the electronic transaction device an electronic communication indicating the current transaction is denied,
wherein the denial is based on determining the current transaction is classified as non-pre-approved, the current transaction exceeds a predetermined threshold, and non-receipt of approval from the second user of the current transaction.

14. The computer program product of claim 13, the program instructions further causing the computing device to update a historical database that contains the historical classification data,
wherein the updating includes the current transaction, results of the classifying, results of the determining, and the non-receipt of approval from the second user.

15. The computer program product of claim 13, wherein the transaction is an attempted purchase and the updating further includes price, purchaser, item, and location, of the attempted purchase.

16. The computer program product of claim 13, the program instructions further causing the computing device to
receive historical transactions of the first user; and
classify each of the historical transactions as being one selected from the group consisting of: non-pre-approved, and pre-approved.

17. The computer program product of claim 16, wherein the classifying of the historical transactions is performed using a natural language classifier.

18. A system comprising:
a processor, a computer readable memory, and a computer readable storage medium;
program instructions to receive an electronic notice of a current transaction being attempted by a first user at an electronic transaction device, the current transaction requiring access to a joint account, the first user and a second user having authority to access an asset in the joint account;
program instructions to compare in real time the current transaction to historical classification data;
program instructions to classify in real time the current transaction based on the comparing; and
program instructions to transmit in real time to the electronic transaction device an electronic communication indicating the current transaction is denied,
wherein the denial is based on determining the current transaction is classified as non-pre-approved, the current transaction exceeds a predetermined threshold, and non-receipt of approval from the second user of the current transaction, and
wherein the program instructions are stored on the computer readable storage medium for execution by the processor via the computer readable memory.

19. The system of claim 18, further comprising:
program instructions to receive historical transactions of the first user; and
program instructions to classify each of the historical transactions as being one selected from the group consisting of: non-pre-approved, and pre-approved.

20. The system of claim 18, further comprising:
program instructions causing the computing device to update a historical database that contains the historical classification data,
wherein the updating includes the current transaction, results of the classifying, results of the determining, and the non-receipt of approval from the second user.
